(19) United States
(12) Patent Application Publication
(10) Pub. No.: US 2024/0204714 A1
(43) Pub. Date: Jun. 20, 2024

(54) INDIVIDUAL TRACKER CONTROL WITH POWER BOOST FOR A SOLAR PANEL INSTALLATION

(71) Applicant: Gamechange Solar Corp., Norwalk, CT (US)

(72) Inventors: Andrew Barron Worden, Redding, CT (US); Scott Van Pelt, Tarrytown, NY (US); Keith Caskey, New York, NY (US)

(73) Assignee: Gamechange Solar Corp., Norwalk, CT (US)

(21) Appl. No.: 18/037,688

(22) PCT Filed: Nov. 18, 2021
(86) PCT No.: PCT/US21/59961

§ 371 Date: Dec. 26, 2023

Related U.S. Application Data
(60) Provisional application No. 63/115,753, filed on Nov. 19, 2020.

(51) Int. Cl. H02S 20/32; F24S 20/00; F24S 30/00; F24S 30/425; F24S 50/20; H02S 50/10

(52) U.S. Cl. CPC H02S 20/32; F24S 30/425; F24S 50/20; H02S 50/10; F24S 2020/16; F24S 2030/115

(57) ABSTRACT

A calibration process of a solar panel installation measures current from a plurality of tracker tables, and based upon the time of day of the detected shade transitions, day of the year and the location of the solar panel installation, the time difference of the detected shade transition for each tracker panel can be used to determine the relative elevation of adjacent tracker tables. The calculation is performed using the known angle of the tracker and the elevation of the sun when the transition occurred to calculate the height offset of the tables. This transition of charging current marks the point where shading ended and the sun elevation is used to calculate the height offset of adjacent tables. This calculation uses the known angle of the tracker and the elevation of the sun when shading ended to calculate the height offset of the tables.

### BACKGROUND OF THE INVENTION

### 1. Technical Field

This disclosure relates generally to a solar panel installation and, more particularly, to apparatuses and assemblies for use in a solar panel installation and a technique for increasing energy production from the solar panel installation.

### 2. Background Information

Photovoltaic modules are used to harness energy from the sun. To maximize the energy output of a photovoltaic module, the sun exposure on a sunny day to the photovoltaic module needs to be as direct as possible. Since the position of the sun changes over the course of the day, fixed solar panels cannot operate at peak performance throughout the day.

Systems for increasing directness of sun exposure upon solar panels may use a tracker (e.g., single or dual axis) that improves efficiency of the photovoltaic module. Single axis trackers are structures on which photovoltaic modules are mounted that rotate from east to west so that the photovoltaic modules follow the arch of the sun over the course of the day.

On days with full cloud cover it is more efficient for a photovoltaic module to lay flat, for example, a photovoltaic module is directed straight upwards, than for a photovoltaic module to follow the path of the sun. The improved efficiency occurs because when flat, a portion of a photovoltaic module does not obstruct the diffuse irradiance from the hemisphere of the sky from reaching the same photovoltaic module. Current sun tracking systems used for addressing this phenomenon use pyranometers to try to adjust for the ratio of diffuse irradiance to global horizontal irradiance in real time. This is not a practical solution as it does not account for the time required to rotate a photovoltaic module from flat to an angle directed toward the sun, in the event that the cloud cover abates, and the sun shines directly on a photovoltaic module (i.e., the ratio of diffuse irradiance to global horizontal irradiance drops quickly). When using a pyranometer, a photovoltaic module tracker positions the photovoltaic module in a relatively flat or flat position once the pyranometer fails to record a beam of light from the sun. On partly cloudy days this causes the tracker system to position a photovoltaic module in a flat position when the sky is overcast for a few minutes and it is not able to return to standard tracking instantaneously when the cloud cover abates. This is deleterious as the solar irradiance, for example solar intensity, of the beam of light from the sun is significantly higher than the diffuse irradiance. When a photovoltaic module is positioned at a sub-optimal angle relative to the sun, for even a short time, there is a much greater loss than the increase in power production of a photovoltaic module being flat when the sky is overcast. The energy gained while a module is flat and the ratio of diffuse irradiance to global horizontal irradiance is high, is coming from light that is already obstructed by cloud cover. The energy gained while a photovoltaic module is tracking to follow the sun is due to direct (beam) sunlight irradiance. The intensity of the beam sunlight is roughly three times larger than the diffuse irradiance. Furthermore, a significant amount of energy is spent rotating a photovoltaic module between positions, for example a flat to normal operating angle. Since currently available solar trackers utilize on board batteries to rotate a photovoltaic module, unnecessary expenditure of power has a significant negative impact on battery life.

As solar energy becomes more common, the plots of land that are optimal for solar installation are becoming more and more scarce. Solar power plants are now commonly being built on properties with large changes in ground elevation and topography. In these instances, ideally it is optimal for each individual sun tracking system within the power plant to rotate on its own schedule of tilt angle vs. time. In particular, in the early morning and late evening, when shadows cast by the trackers are longest, rotating each tracker at its own tilt angle to account for relative elevation of each tracker would reduce/minimize shading of adjacent trackers. There is a need for a technique that accounts for the actual elevation and topography of the landscape that the solar power plant is located on.

### SUMMARY OF THE DISCLOSURE

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to an aspect of the present disclosure, an assembly for a solar panel installation comprises a stationary structural member having a length that extends longitudinally to a distal member end; a rotatable shaft rotatably connected to the stationary structural member at the distal member end to rotate about a rotatable axis; a drive mechanism connected to the rotatable shaft to rotate the rotatable shaft about the rotational axis in response to a command signal; a node controller that provides the command signal; a photovoltaic panel that rotates with the rotatable shaft about the rotatable axis and provides electrical current and is located at a known rotational position about the rotational axis; and a current sensor that measures the electrical current and provides a sensed current signal indicative thereof; where, the node controller includes executable program instructions that receive the sensed current signal, and based upon (i) the known position of the photovoltaic panel (ii) sun angle on the photovoltaic panel for day of the year and time of the day of the year and (iii) the received sensed current signal, the node controller determines and stores height data indicative of the topography the stationary structural member is located on with respect to an adjacent assembly for the solar panel installation, as measured over a plurality of hours by the current sensor that provides the sensed current signal.

The drive mechanism may include a motor.

The drive mechanism may comprise a piston.

The node controller may compute the height data value, which includes a height offset value indicative of difference in height between the assembly and the adjacent assembly.

According to another aspect of the disclosure, a node controller for a solar panel installation with a drive mechanism and a photovoltaic panel of an associated tracker table rotatably mounted on a stationary structural member to rotate about the rotational axis, the node controller comprises a processor; a tilt measuring device configured to measure rotary position of the photovoltaic panel about the rotational axis and provide a tilt signal indicative thereof; a clock; a memory comprising a height value indicative of the relative difference in elevation of the associated tracker table versus an adjacent tracker table, for use with the processor to determine what the tilt of the solar panel should be for a time of day, a day, and the height offset value and based upon one or more of the following parameters: sun elevation, sun azimuth, row spacing and/or slope the associated tracker table is locate on for backtracking analysis; one or more drivers configured to signal the drive mechanism to operate until an appropriate tilt of the photovoltaic panel is reached; and a wireless communication device for communicating with another device.

The another device may be a master controller that communicates with a plurality of node controllers each uniquely associated with a one of the associated tracker table and adjacent tracker tables of the solar panel installation.

The master controller may comprise a snow/water depth sensor that provides data that can trigger a warning and/or an adjustment in an operational tilt range of the solar panel.

The processor may include executable program instructions that cause the node controller to receive a measured current signal from the photovoltaic panel to (i) determine at what time the sun substantially illuminates the associated tracker table that includes a photovoltaic (PV) panel selectively electrically connected to a battery, based upon a detected increase in the measured current signal, and to (ii) determine at what time the sun is shaded from substantially illuminating the associated tracker table based upon a detected reduction in the measured current signal.

The processor may include executable program instructions that cause the node controller to measure current from the associated tracker table during a calibration process to determine the time of day when the sun begins to directly illuminate the photovoltaic panel without shading from a first adjacent tracker table in the East-West direction, and to measure the current from the photovoltaic panel during the calibration process to determine the time of day when the sun stops directly illuminating the associated tracker table because of shading from a second adjacent tracker table in the East-West direction.

The processor may include executable program instructions that cause the node controller to rotate the photovoltaic panel to track the sun accounting for the elevation of the associated tracker table relative to first and second adjacent tracker tables in East-West directions using the height value indicative of the height difference of the associated tracker table versus one of the first and second adjacent tracker tables, and sets a tilt angle for the associated tracker table based upon the height value to increase energy output of the associated tracker table.

The processor may include executable program instructions that cause the node controller to rotate the photovoltaic panel of the associated tracker table to track the sun accounting for the elevation of adjacent tracker tables in the East-West direction.

According to yet another aspect of the present disclosure, a master controller for communicating with a plurality of node controllers of a solar panel installation, each of the plurality of node controllers associated with one of a plurality of tracker tables, the master controller comprising a processor configured with a memory and a communication device in order to periodically synchronize node clocks of the plurality of node controllers with a master clock of the master controller to ensure coordinated tilts of the plurality of tracker tables; command the plurality of node controllers to perform a power boost calibration routine that for each of the plurality of tracker tables measures, periodically over a period of hours, electrical current generated by a photovoltaic panel commanded to a known calibration position; receive, for each of the plurality of tracker tables, shade transition data indicative of a transition of the electrical current from each of the plurality of tracker tables; compute relative elevation data for each of the plurality of tracker tables based upon the shade transition data indicative of a transition of the electrical current from each of the plurality of tracker tables; and transmit the relative elevation data to the plurality of node controllers.

According to still yet another aspect of the present disclosure, a master controller for communicating with a plurality of node controllers of a solar panel installation, each node controller associated with one of a plurality of tracker tables, the master controller comprising a processor configured with memory and a communication device in order to (i) periodically synchronize node clocks of the node controllers with a master clock of the master controller to ensure coordinated tilts of the plurality of tracker tables; (ii)command the node controllers to perform a power boost calibration routine that measures, periodically over a period of hours, electrical current generated by a photovoltaic panel commanded to a known calibration position; and (iii) receive, from each of the node controllers, a height offset value indicative of the height of the tracker table associated with the node controller relative to an immediately adjacent tracker table, where each of the height offset values is computed by its associated node controller based upon measured shade transitions as determined by the associated node controller monitoring electrical current from its associated tracker table held in a known position of a period of hours during a calibration day.

According to a further aspect of the present disclosure, a method of determining a height offset data indicative of height offset between a first solar tracker table and an adjacent second solar tracker table, the method comprising rotating a photovoltaic panel of the first solar tracker table to a known position; measuring electrical current from the first solar tracker table and providing a measured current signal indicative thereof; comparing the measured current signal with a rolling time average of the measured current signal to determine if a shade transition has occurred; repeating the steps of measuring and comparing if the step of comparing determines that a shade transition has not occurred; and when it is determined that a shade transition determine has occurred, calculating the height offset data indicative of a difference in height between the first solar tracker table and the second solar tracker table.

The calculating the height offset data may use (i) known position of the photovoltaic panel (ii) sun angle for day of the year and time of the day of the year and (iii) the measured current signal.

### BRIEF DESCRIPTION OF THE DRAWINGS

FIG. 1 illustrates a solar panel installation;

FIG. 2 illustrates a first embodiment of a stationary structural member;

FIG. 3 illustrates a second embodiment of a stationary structural member;

FIGS. 4 and 5 illustrate an exemplary embodiment of a rotatable shaft;

FIG. 6 illustrates adjacent segments coupled together with a coupler;

FIG. 7 illustrates a bearing assembly configured to rotatably mount the rotatable shaft;

FIG. 8 illustrates two adjacent bearing assemblies configured to rotatably mount the rotatable shaft;

FIG. 9 illustrates an exploded view of an embodiment of a bearing assembly;

FIG. 10 illustrates an exemplary embodiment of the drive mechanism;

FIG. 11 illustrates an exemplary embodiment of a wind break plate and support members operably positioned on the rotatable shaft;

FIG. 12 illustrates an exemplary embodiment of a wind break plate, support members and a solar panel operably positioned on the rotatable shaft;

FIG. 13 illustrates an exemplary embodiment of a node controller with the rotatable shaft;

FIG. 14 is a simplified pictorial illustration of a solar panel installation with a plurality of solar panel arrays, also referred to as rows or tracker tables;

FIG. 15 is a block diagram illustration of an exemplary embodiment of a node controller;

FIG. 16 is a flow chart illustration of a power boost calibration technique to assess the topography the solar power plant is located on to provide data to control logic to more accurately position PV panels based upon the solar power plant topography;

FIGS. 17A-17J are pictorial illustrations of trigonometry associated with calculating a uniform tracking angle Θ that avoids shading with an adjacent tracker on one side given the height offset (Δh) of the trackers; and

FIG. 18 is a pictorial illustration of trigonometry associated with the calculating the Projection Angle (<P).

### DETAILED DESCRIPTION

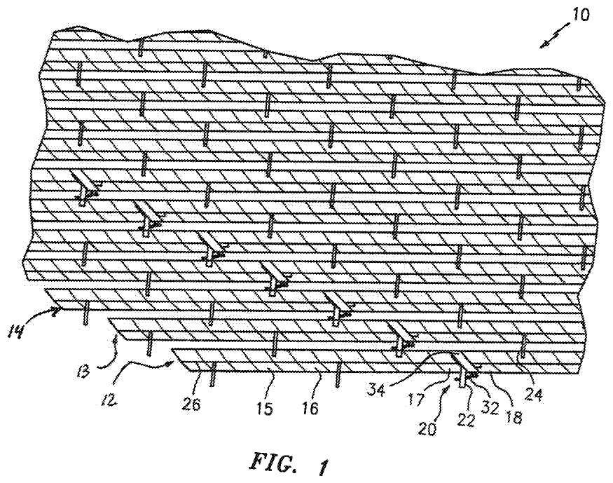

FIG. 1 illustrates a solar panel installation 10 that includes one or more solar panel arrays 12-14. Each of these solar panel arrays 12-14 includes one or more solar panels 15-18 (e.g., a linear array of solar panels) mounted to a racking structure 20. Each racking structure 20 includes a plurality of stationary structural members 22, 24, a rotatable shaft 26, a plurality of bearing assemblies 28, 30 (see FIG. 5), and at least one drive mechanism 32. Each racking structure 20 may also include at least one wind break panel 34 for configuring with the drive mechanism 32.

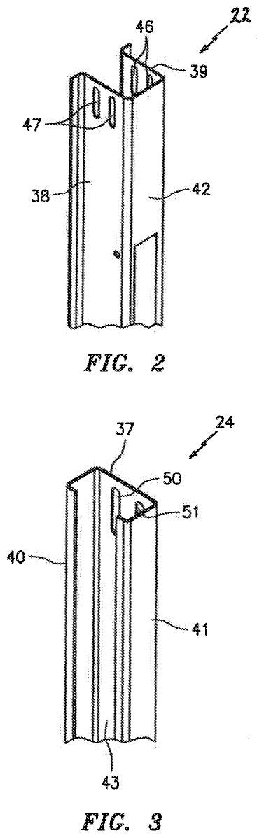

FIGS. 2 and 3 respectively illustrate exemplary embodiments of the stationary structural members 22, 24. The stationary structural member of FIG. 2 is configured as a center post, or drive mechanism support post. The stationary structural member of FIG. 3 is configured as a standard post, or support post. In some embodiments, one or more of the stationary structural members may be securely anchored to the ground. For example, a bottom portion of the member's length may be buried in the ground and/or otherwise secured to or with a foundation, which may be a driven pile, helical screw, screw, precast or cast in place (e.g., Pour-in-Place™ installation system available from Gamechange Solar Corp.) or any other foundation type. In other embodiments, one or more of the stationary structural members may be anchored to another structure such as, but not limited to, a building roof top.

Referring still to FIGS. 2 and 3, each stationary structural member has a length. This length extends longitudinally (e.g., substantially vertically when installed) from its bottom portion to a distal (e.g., top) member end 37, 39. Each stationary structural member may include one or more flanges 38-41 and a central web 42, 43, which extends laterally (e.g., horizontally when installed) between the respective first and the second flanges. Each of the flanges 38, 39 of FIG. 2 includes one or more mounting apertures such as, but not limited to, a pair of longitudinal slots 46, 47. The web 43 of FIG. 3 similarly includes one or more mounting apertures such as, but not limited to, a pair of longitudinal slots 50, 51.

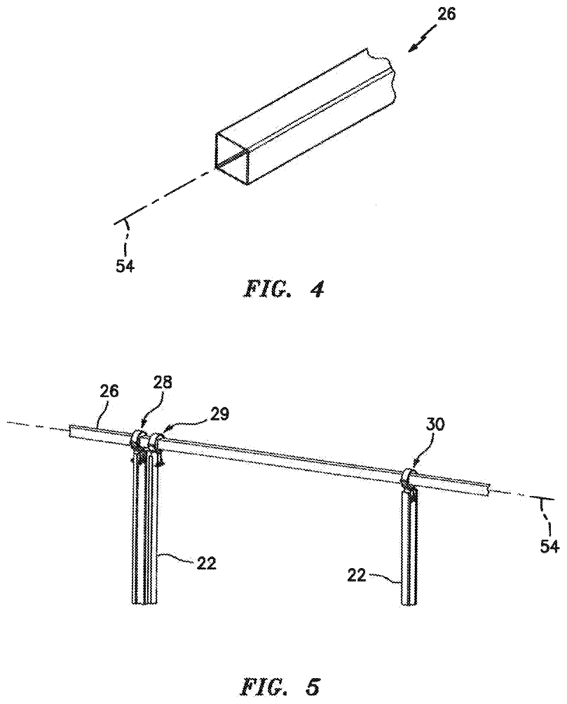

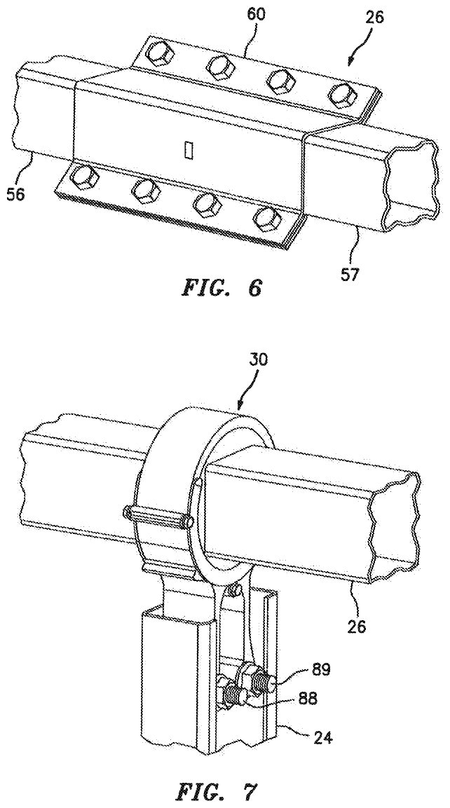

FIGS. 4 and 5 illustrate an exemplary embodiment of the rotatable shaft 26. The rotatable shaft has a length, which extends axially (e.g., substantially horizontally when installed) along a rotational axis 54. The rotatable shaft may be configured as a single length of shaft as shown in FIG. 5. Alternatively, as shown in FIG. 6, the rotatable shaft 26 may be configured with a plurality of shaft segments 56, 57, where adjacent segments are coupled together with a coupler 60 (e.g., a clamping sleeve) and/or otherwise connected to one another. The exemplary rotatable shaft of FIG. 4 has a polygonal (e.g., square) cross-sectional geometry; however, the rotatable shaft of the present disclosure is not limited to such a geometry.

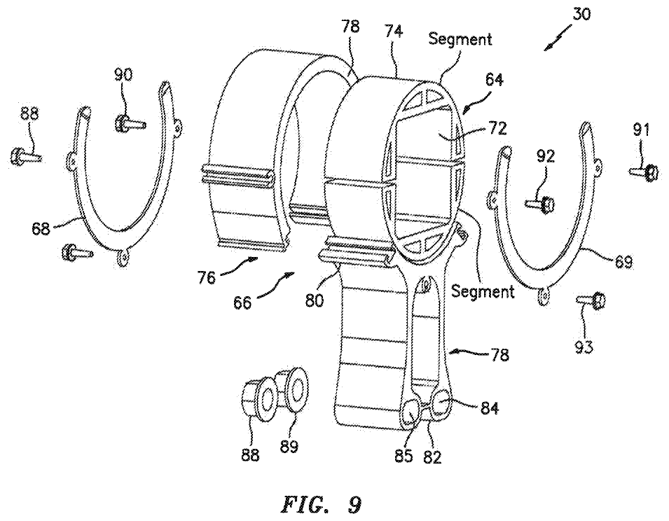

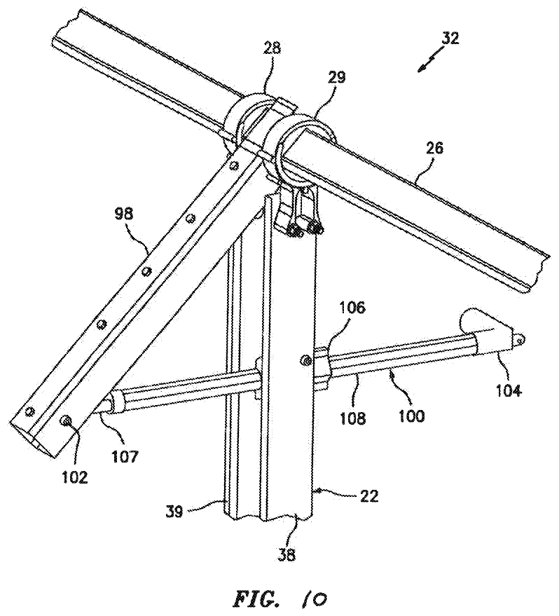

Referring to FIGS. 5, 7 and 8, bearing assemblies 28-30 are configured to rotatably mount the rotatable shaft 26 to the stationary structural members 22. Referring now to FIG. 9, each bearing assembly may include a bearing wheel 64, a bearing collar 66 and one or more capture rings 68-69.

Referring to FIG. 9, the bearing wheel 64 has a rotational axis, which is co-axial with the rotational axis 54 of the rotatable shaft 26 (see FIG. 5). The bearing wheel 64 includes and extends radially between an inner surface 72 and an outer surface 74. The inner surface 72 at least partially forms a bore. This bore extends axially through the bearing wheel 64 along the rotational axis 54. The bore may have a polygonal (e.g., square) cross-sectional geometry configured complementary to the geometry of the rotatable shaft. The bore may thereby receive the rotatable shaft axially therethrough. Of course, in other embodiments, the bore may be slightly larger than the rotatable shaft 26 and/or have a different geometry than that of the rotatable shaft where, for example, an intermediate element such as a bushing or a sleeve is disposed between the bearing wheel and the shaft. The outer surface 74 may have a circular cross-sectional geometry.

The bearing wheel 64 may be formed as a single, integral body, as shown in FIGS. 10-12. Alternatively, the bearing wheel may be formed from a plurality of discrete segments (e.g., discretely formed halves) as shown in FIGS. 9 and 10. These segments may be connected together, or not connected together; e.g., merely abutted against one another.

Referring again to FIG. 9, the bearing collar 66 may include a collar base 76 and a collar mount 78. The collar base 76 includes an inner surface 72 configured to circumscribe and slidingly engage the outer surface 74 of the bearing wheel 64. This collar base 76 may be formed as a single integral body. Alternatively, the collar base 76 may be formed from a plurality of discrete segments secured together to form a hoop structure as shown in FIG. 9. The segments of

FIG. 9, in particular, are secured together via locking tongue and groove (mortise) joints; however, other attachment methods and/or hardware may be used to secure the segments together.

In the exemplary embodiment of FIG. 9, bottom segment 80 extends between about 30 degrees and about 90 degrees around the rotational axis 54. The top segment extends between about 330 degrees and about 270 degrees around the rotational axis 54. The present disclosure, of course, is not limited to the foregoing values. For example, in other embodiments, each segment may extend about 180 degrees around the rotational axis 54, or otherwise.

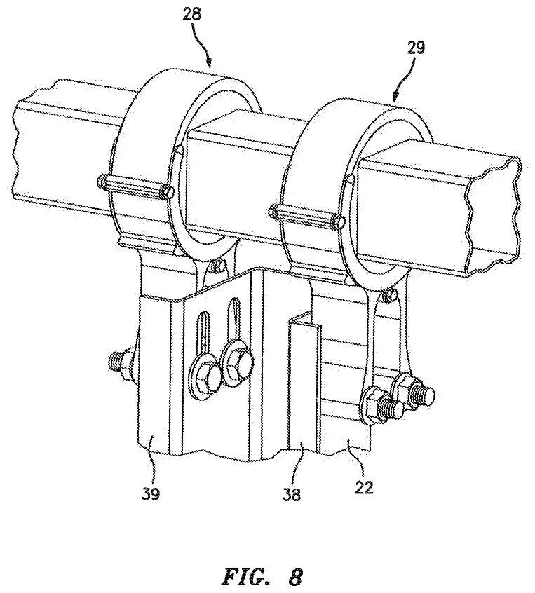

The collar mount 78 projects radially out (e.g., down) from the collar base 76 (e.g., the bottom segment) to a distal mount end 82. The collar mount 78 may be formed integrally with the collar base 76 (e.g., the bottom segment), or attached thereto. The collar mount 78 includes a plurality of mounting apertures 84, 85 at the distal mount end 82. Each of these mounting apertures 84, 85 extends axially through the collar mount 78. The mounting apertures 84, 85 are configured to respectively receive fasteners 88, 89 (e.g., bolts or otherwise) for securing the collar mount 78 to a respective one of the stationary structural members 22, 24 as shown in FIGS. 7 and 8. In particular, each fastener extends through a respective one of the mounting apertures in the collar mount and a respective one of the mounting apertures (e.g., slots) 84, 85 in the stationary structural member 22, 24. The fasteners may be positioned within the mounting apertures (e.g., slots) in the stationary structural member so as to adjust the vertical height or lateral position of the bearing assembly; e.g., in order to ensure the rotational axis is as straight-line and/or level as possible as the rotatable shaft passes through the bearing assemblies. The fasteners may then be tightened to clamp the collar mount 78 to the respective stationary structural member 22, 24

The capture rings 68, 69 are secured to opposing axial sides of the collar base 76 using, for example, one or more fasteners (e.g., screws) 88-93. Each capture ring 68, 69 projects radially inward from the inner surface 78 of the collar base 76 and thereby overlaps an axial end of the bearing ring 66 to prevent that end from sliding out of the bore of the collar base.

FIG. 10 illustrates an exemplary embodiment of the drive mechanism 32. This drive mechanism includes a drive arm 98 and an actuator 100. The drive arm 98 is substantially axially aligned with the stationary structural member 22 along the rotational axis. A first end of the drive arm is secured to the rotatable shaft 26. Distal end flanges of the drive arm 98, for example, are clamped around the rotatable shaft 26 between two adjacent and proximate bearing assemblies 28, 29.

The actuator 100 is substantially axially aligned with the stationary structural member and the drive arm along the rotational axis. The actuator 100 is pivotally connected to the drive arm 98. More particularly, a first end of the actuator projects through an opening in the drive arm and is pivotally connected to and between two sides of the drive arm at its second end by a shaft; e.g., a threaded rod 102. The actuator is also connected to the stationary structural member 22; e.g., the center post. More particularly, an intermediate portion of the actuator 100 is pivotally connected to and between the first and second flanges 38, 39 of the stationary structural member 22. An end portion of the actuator 100 may project through an opening in the web of the stationary structural member to a second end of the actuator, where a motor 104 for actuating the actuator may be located. The intermediate portion of the actuator may be connected to the flanges 38, 39 by an actuator mount 106 clamped therearound, or with trunnion blocks welded to the actuator housing, and a shaft.

The actuator 100 may, for example, be a hydraulic piston actuator or a screw drive actuator. The actuator may thereby include a pushrod 107 and a base 108, where the push rod 107 projects out from and slides within and relative to the base. The pushrod 107 may be pivotally connected to the drive arm 98. The base 108 may be pivotally connected to the stationary structural member 22. Of course, the drive mechanism of the present disclosure is not limited to the foregoing exemplary actuator configuration or mounting scheme.

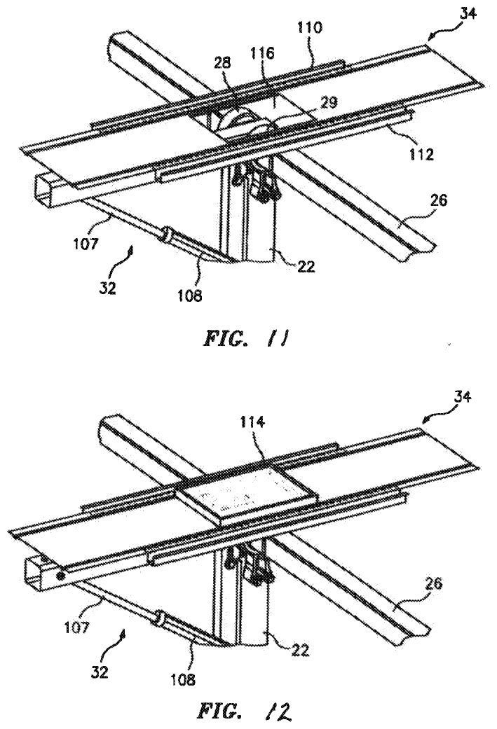

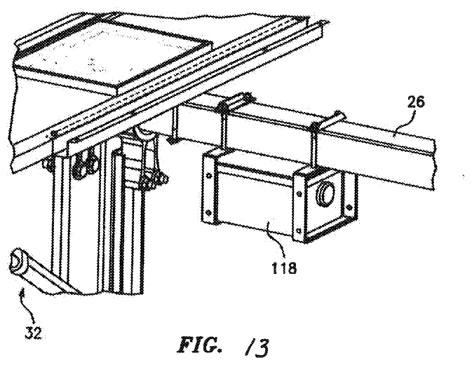

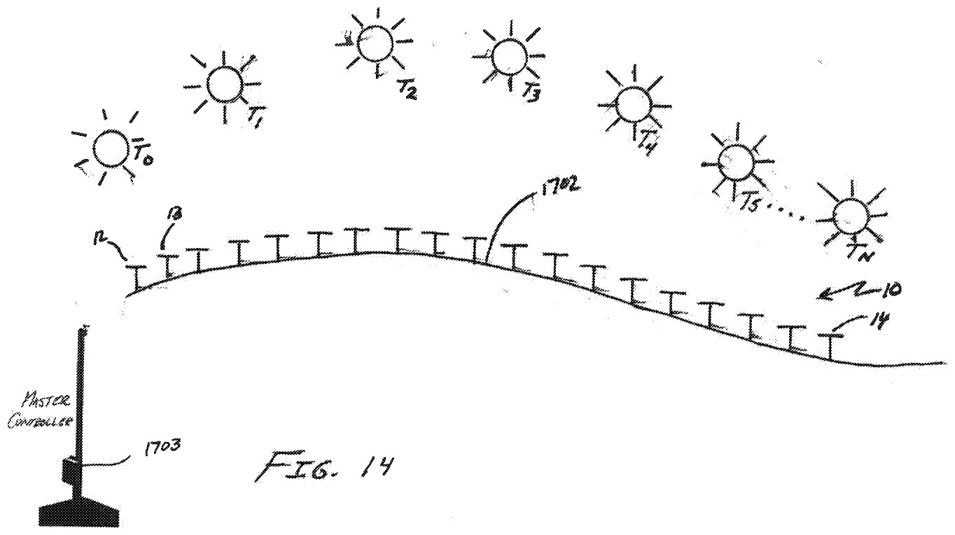

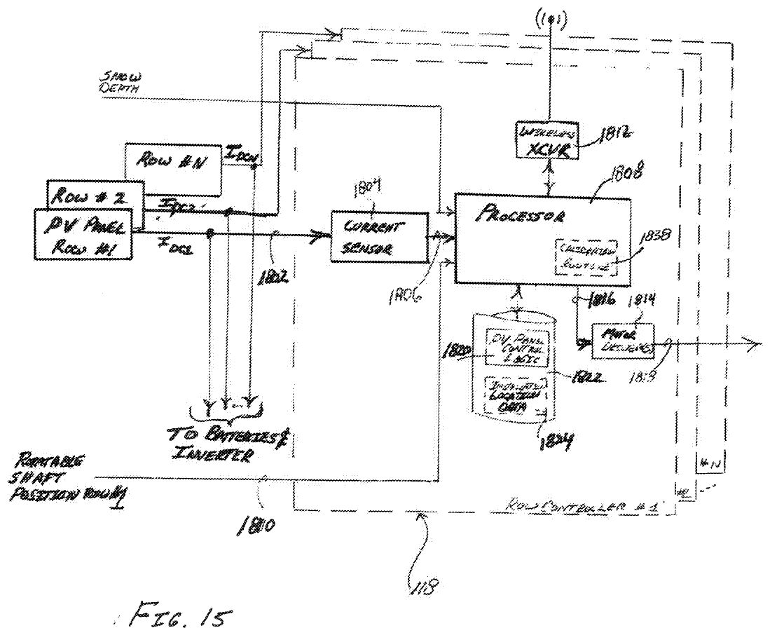

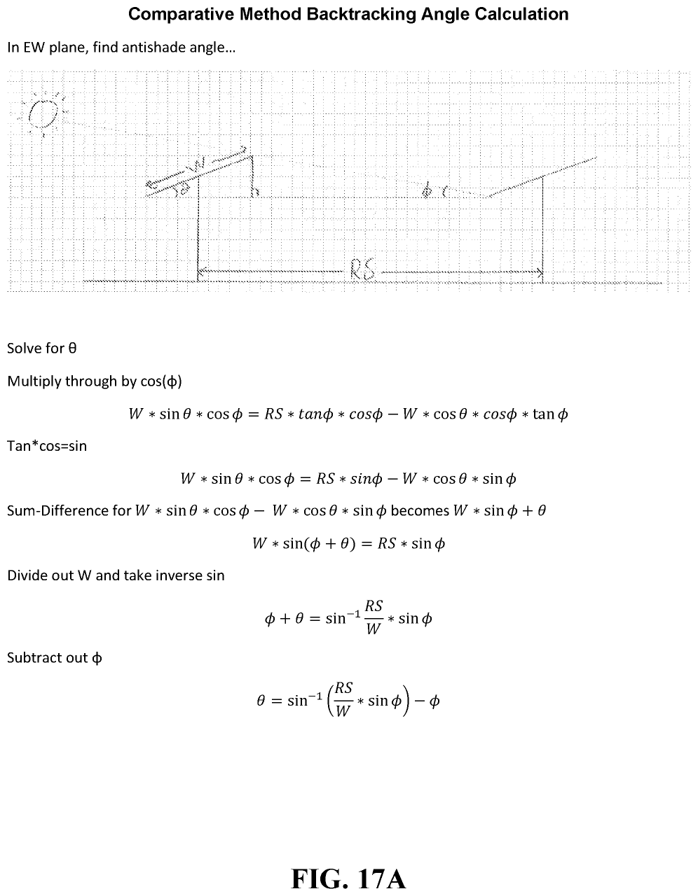

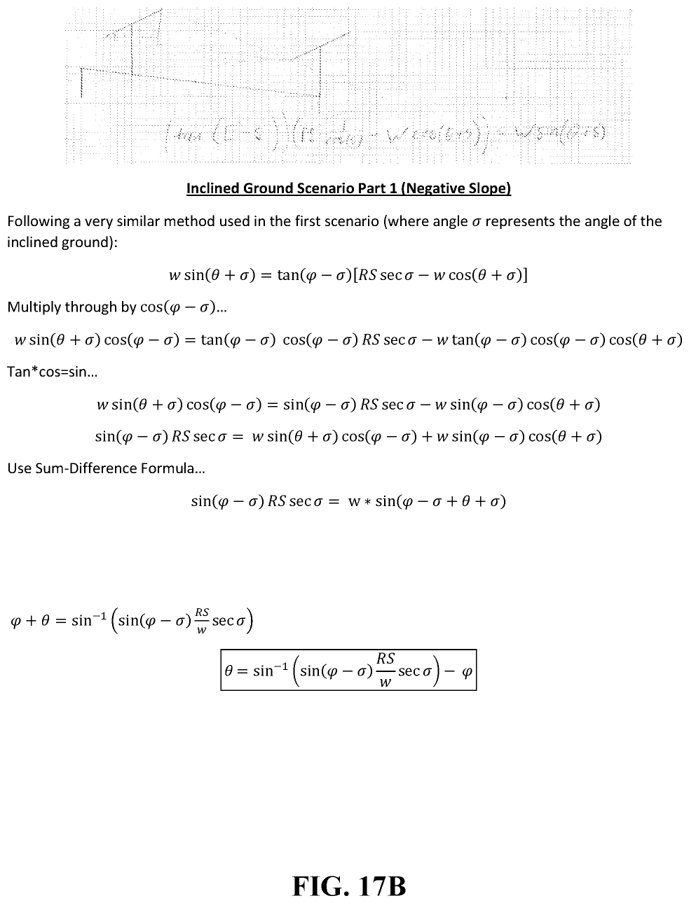

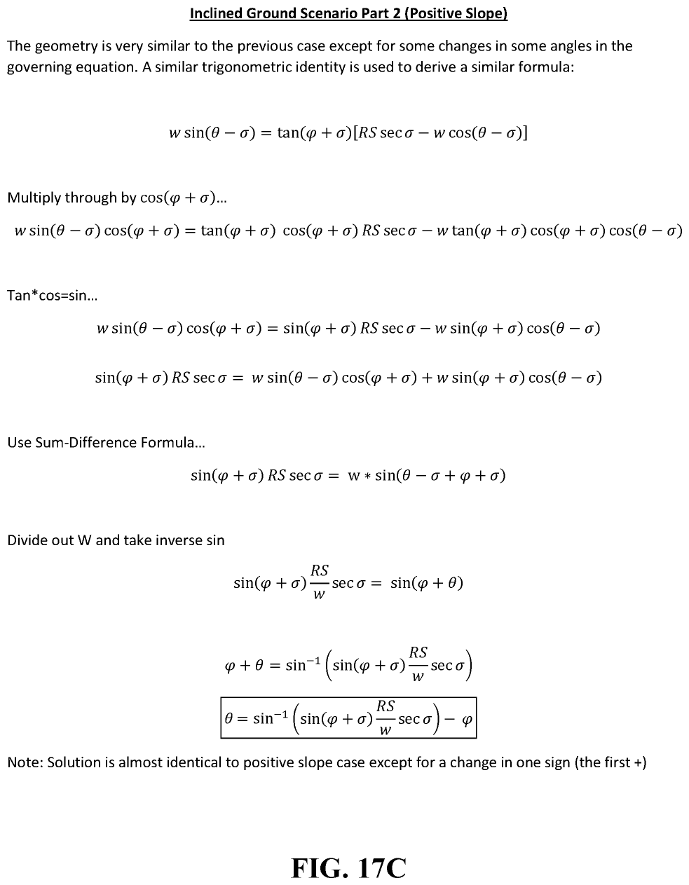

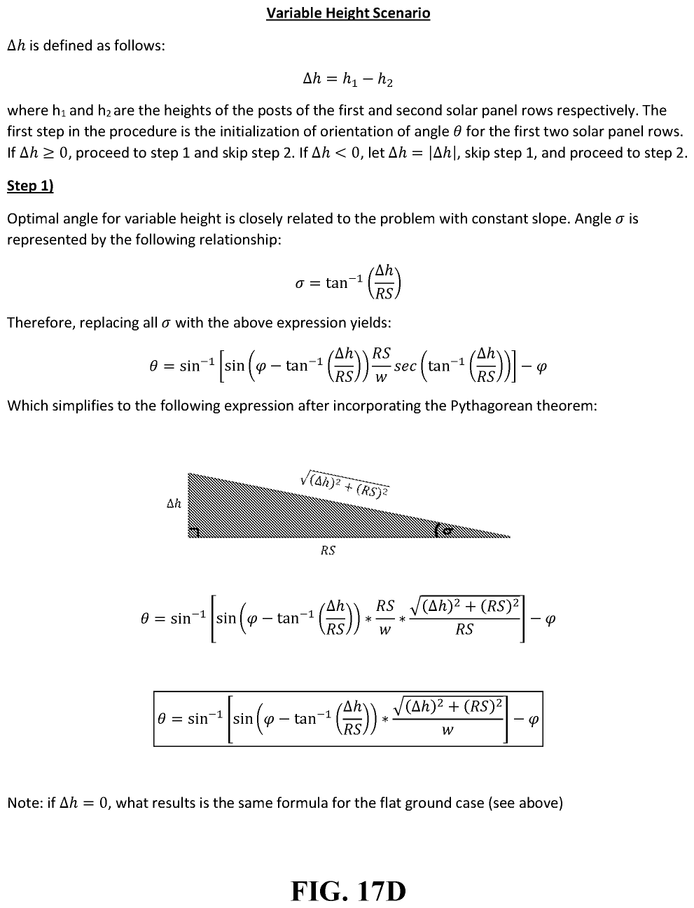

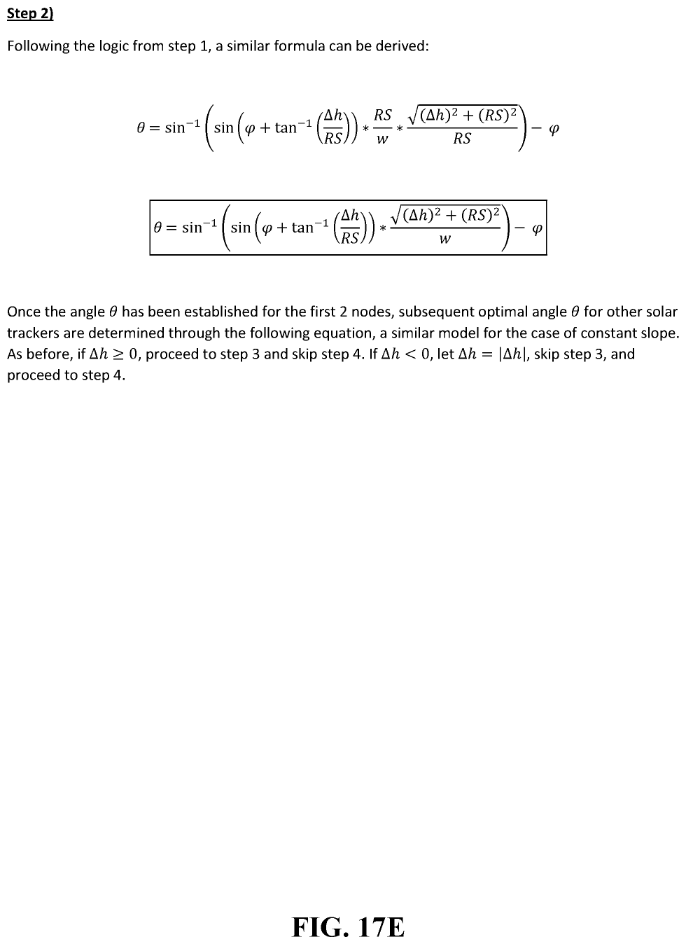

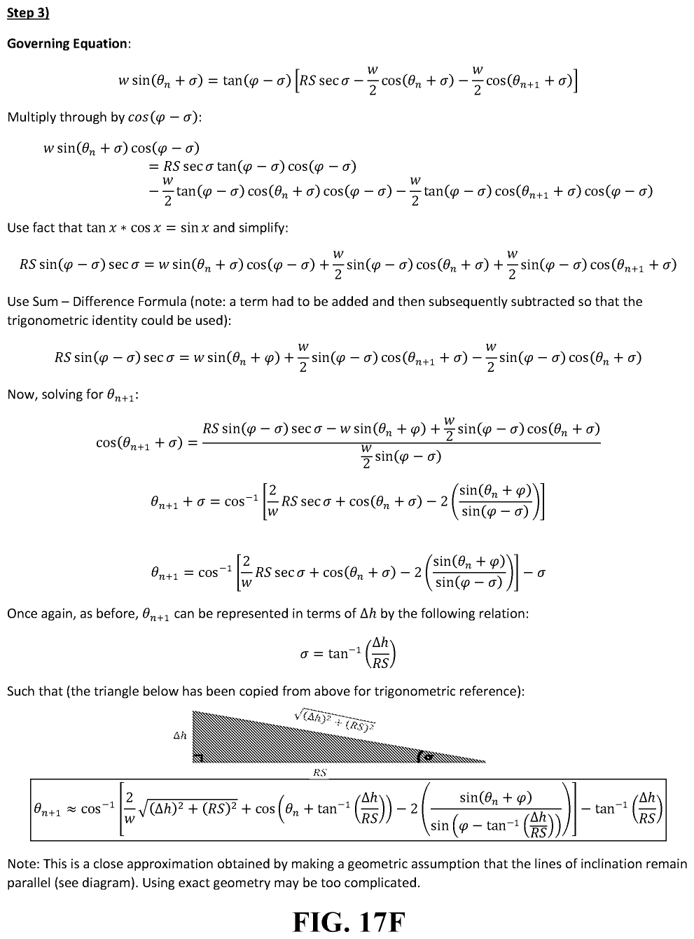

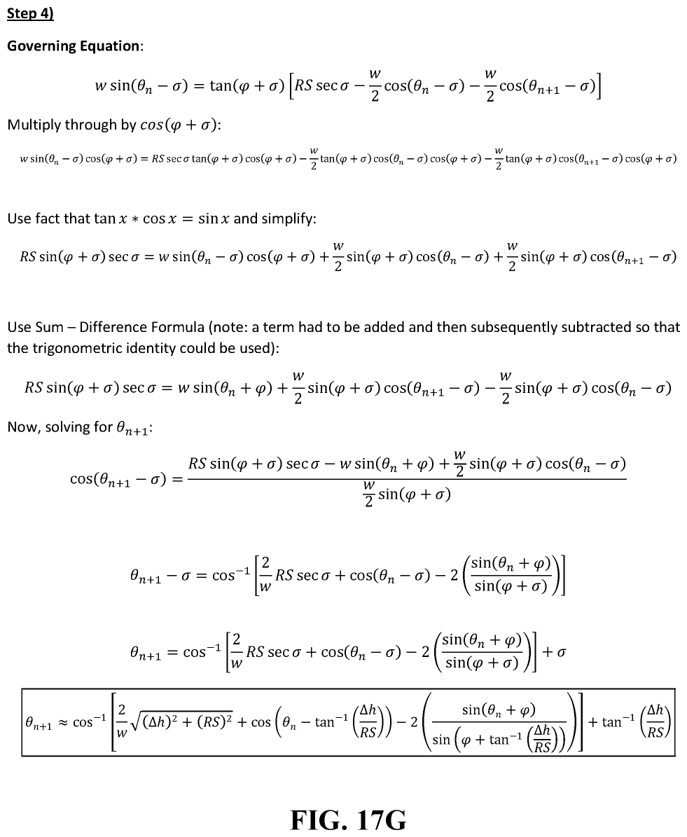

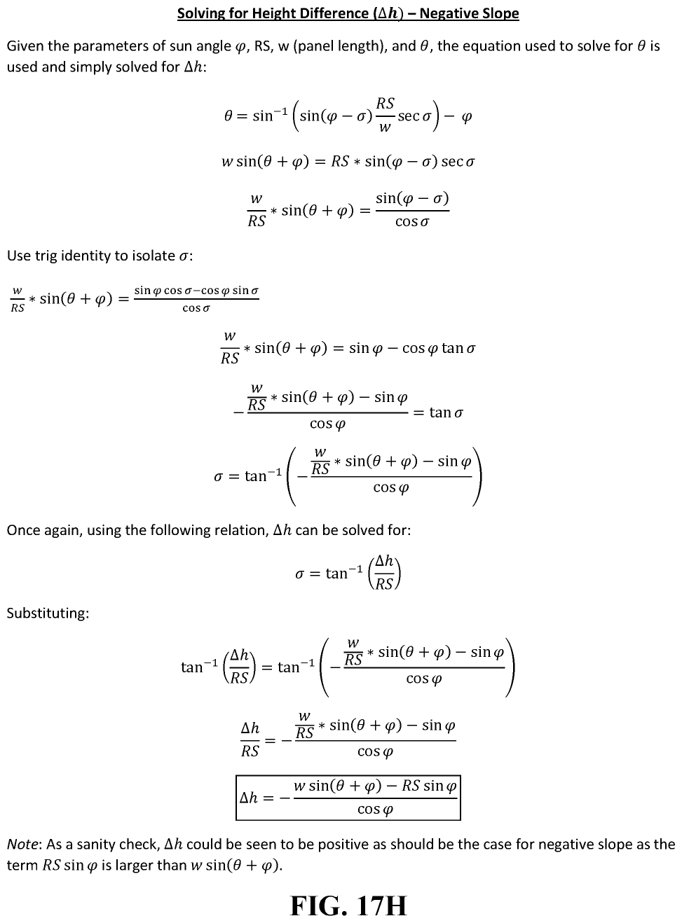

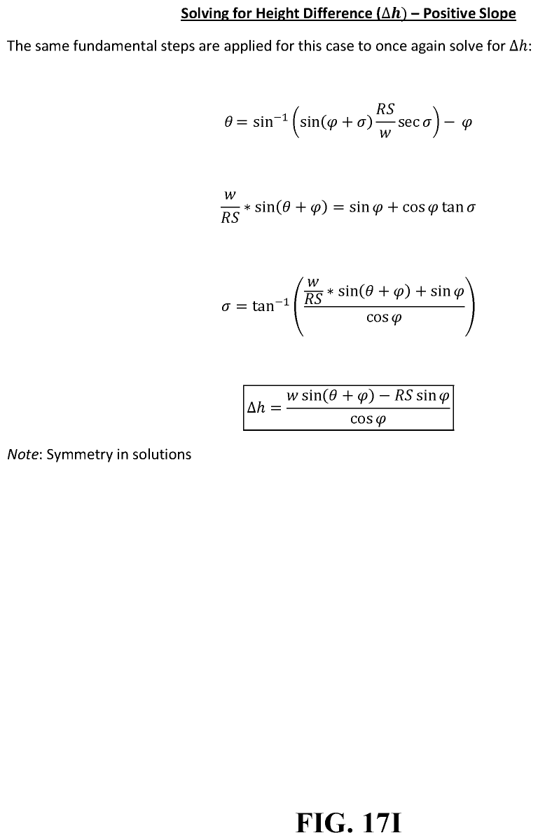

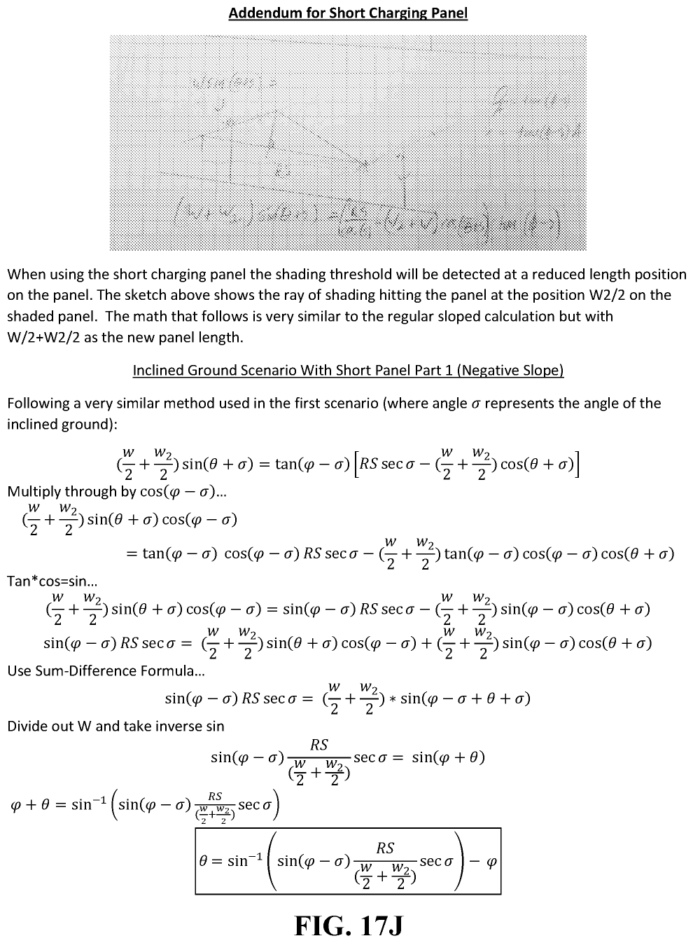

FIGS. 11 and 12 illustrate an exemplary embodiment of the wind break plate 34. This wind break plate 34 is mounted to the rotatable shaft 26. In particular, the wind break plate of FIGS. 16 and 17 is mounted to a pair of support (e.g., purlin) members 110, 112, which in turn are mounted to the rotatable shaft 26. The support members are located on opposing sides of the stationary structural member 22 and/or two respective bearing assemblies 28, 29 along the rotational axis. The wind break plate 34 is configured to at least partially cover the distal member end of the stationary structural member and the drive mechanism. The wind break plate may also provide a mounting surface for a solar panel 114, which is operable to provide power to the drive mechanism 32. The solar panel 114 may be nested with an opening 116 in the wind break plate 34 over the distal member end.

Referring again to FIG. 1, a pair of the solar panels 17, 18 are located adjacent to and on opposing sides of the wind break plate. The wind break plate may substantially close a lateral gap between the solar panels.

The solar panel installation of FIG. 1 includes a control system. This control system may include a single node controller, or a plurality of node controllers depending upon the specific configuration of the solar panel installation. For example, the control system may include a single node controller where the solar panel installation includes a single drive mechanism. Alternatively, the control system may include a plurality of node controllers where the solar panel installation includes multiple drive mechanisms, and those mechanisms are divided into different nodes (of one or more mechanisms) with independent control. The control system may also include a master controller in signal communication (e.g., hardwired and/or wirelessly connected) with the one or more node controllers.

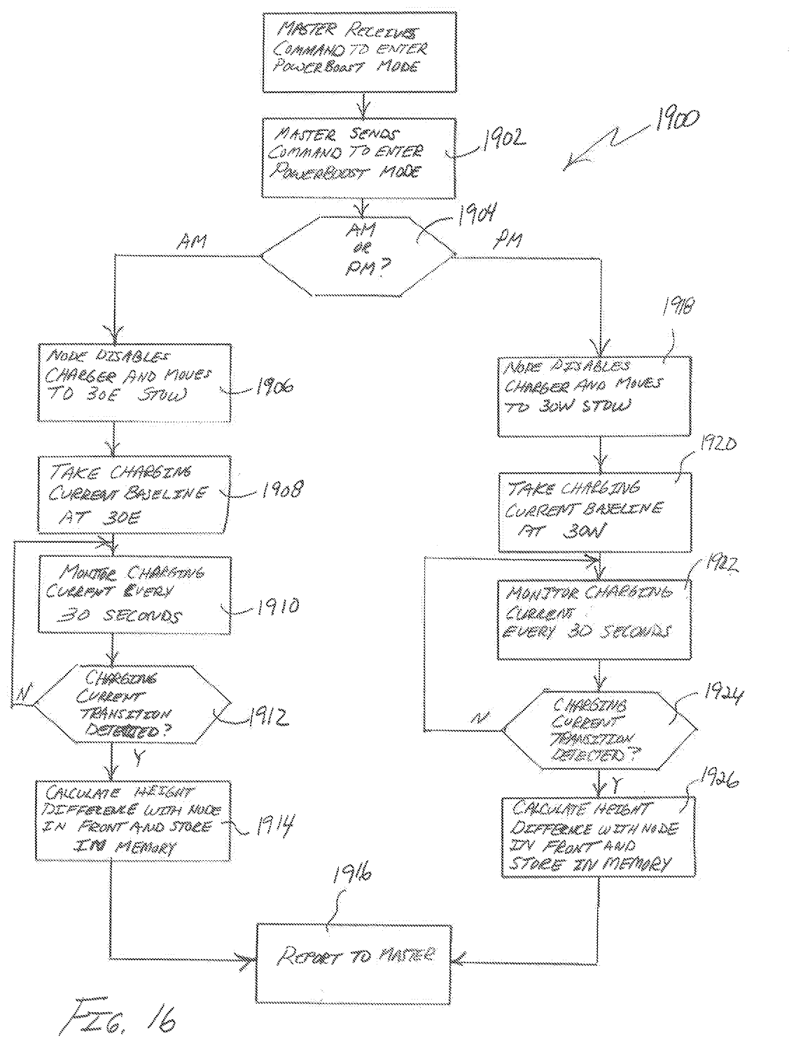

An exemplary embodiment of a node controller 118 is shown with the rotatable shaft 26 in FIG. 13. This node controller 118 may include a processor, a tilt measuring device (e.g., a sensor), a clock, a memory, one or more motor drivers, and a communication device (e.g., a transceiver, an input port and/or an output port). The tilt measuring device is configured to measure the tilt of the solar panels, which may be measured directly or indirectly through the rotational position of the rotatable shaft 26. The processor includes executable programs to determine what tilt the solar panel array should be positioned at a certain time of day based on one or more of the following parameters: location; sun elevation and/or azimuth; row spacing; and slope for backtracking analysis. The motor drives are configured to command the motor for the actuator to turn and actuate the actuator until an appropriate solar panel tilt is obtained. The communication device is configured to provide communication between the node controller and another device; e.g., the master controller. A snow/moisture depth sensor may also be included with or connected to master controller. This snow/moisture depth sensor may provide data to the master controller, which can transmit a signal to the node controllers indicative of the snow/moisture depth status.

The master controller may be configured to communicate wirelessly with one or more node controllers. The master controller is configured to sync up the node controller clocks to a master controller clock periodically (e.g., every day) to make sure all of the clocks are at the exact same time so tilts are uniform. The master controller is also configured to receive information from the node controllers about time of day and tilt to see if any solar panels are not at proper tilt or are not running. The master controller may subsequently relay this data to another device such as a cell phone, or wireline the data to the cloud or customer communications network for service call notification and analysis.

The master controller may include or be connected to a wind speed sensor (e.g., an anemometer) configured to read wind speed. The master controller may monitor the wind speed and the tilt of the system as determined, for example, using a lookup table for the site. The master controller may calculate at what wind speed the system should move towards a stow position. The master controller may then broadcast control signals to the node controllers to move the solar panels toward their stow position in a certain increment in degrees of tilt. The master controller may then continue to monitor the windspeed, and if more adjustments are needed to move further towards full stow position due to increasing windspeed the master controller may send additional broadcast stow messages to the node controllers. By providing incremental partial stow messages and movements to match up tilt with windspeed and only change the tilt to that closest to optimal based on monitored windspeed, the solar panels may not need to be moved to the fully stowed position, battery drain may be minimized and/or the power output of the entire array may be maximized by reducing time that the solar panels are moved away from optimal power producing position in high speed wind conditions. Also, by having the stow position be at the fully retracted actuator position with panels facing west, positioning in the stow position may be optimized to be mostly in the afternoon hours when thunderstorms are prevalent, which increases the average stow windspeed dramatically, which again reduces battery usage and reduces any power loss from the array being moved out of optimal power producing tilt due to wind events.

The shading of one tracker on the adjacent trackers in the morning and evening is a cause of meaningful reduction in energy production of the solar power plant. Common practice in the industry is to “backtrack” or anti-shade in the morning and the evening to reduce (e.g., minimize) shading. Backtracking refers to rotating the PV modules to a shallower tilt so that they do not cast a shadow on the adjacent rows. That is, backtracking is the phenomena of rotating the photovoltaic modules to a shallower angle, in relation to an adjacent photovoltaic module, when the sun elevation is low in order to avoid shading between rows of single axis solar trackers. Implementing the use of anti-shading calculations increases power production because shading causes more production loss than a lower incident angle. Conventional anti-shading calculations assume either no slope or a constant slope to determine the geometry between rows. This design simplification is often not consistent with the large changes in ground elevation and topography that the solar panel plant may be located on. This can cause less than optimal tracking because a panel that is on a slight hill will be higher and thus cast shade on the next row if that height offset is not accounted for. Although this results in the modules not being rotated so they are perpendicular to the beam of light coming from the sun, the output of the PV modules is still larger than if the PV modules were perpendicular to the sun but partially shaded. However, a tracker can improve its power generation by providing the anti-shading calculations with data indicative of the topography the tracker is actually located on.

FIG. 14 is a simplified pictorial illustration of the solar panel installation 10 with a plurality of solar panel arrays 12-14, also referred to as rows or tracker tables. The solar panel installation 10 is located on a non-planar topography 1702 and includes a master controller 1703 having for example a processor, memory and a transceiver to communicate with the node controllers. In an exemplary embodiment, a tracker according to an aspect of the disclosure uses a calibration process to gather installation location data indicative of the topography (e.g., non-planar) each tracker table is actually located on and the spacing of adjacent rows/tracker tables (e.g., 12 and 13). This installation location data is then used by the node controller 118 (see FIG. 13) of each row to more accurately position panels in the row to increase power generation, rather than merely assuming the installation 10 is located on a planar surface with no elevation change.

FIG. 15 is a block diagram illustration of the node (e.g., row) controller 118. Each controller 118 may be configured to control one row/tracker table of the solar panel installation 10 (see FIG. 14). The node controller receives a DC current signal on a line 1802 from a row of solar panels. The DC current signal is input to a current sensor 1804 that provides a measured current signal on line 1806. A processor 1808 receives the measured current signal on the line 1806 and may also receive a rotatable shaft position signal on a line 1810. The controller 118 also includes a wireless transceiver 1812 that allows the controller 118 to wirelessly communicate, for example, with a master controller (not shown) that may be located at the site of the solar panel installation 10. The wireless transceiver 1812 may be a low power transceiver, such as for example a ZIGBEE® transceiver. The transceiver may also be configured to transmit and receive packetized data via the Internet for communications with a remotely located server (not shown). In the embodiment illustrated in FIGS. 14 and 15, each row of the solar panel installation 10 has its own controller 118. To position the panels, the controller also includes at least one motor driver 1814 that receives a command signal on a line 1816 from the processor 1808 and provides a drive signal on a line 1818 to an actuator. The actuator may be actuator 100 illustrated in FIG. 14 with the motor 104.

Referring still to FIG. 15, based upon time of day, day of the year, sky conditions, and environmental conditions such as snow and wind, the processor 1808 performs executable program instructions associated with solar panel control logic 1820 to control panel position. The solar panel control logic may be stored in non-volatile memory associated with the processor 1808 (e.g., on chip), or remote in a memory 1822 in communication with the processor 1808. Notably, the controller 118 includes installation location data 1824 indicative of the non-planar topography 1702 (FIG. 14) that the solar panel installation 10 is located on. The processor 1808 also includes a calibration routine 1826 that generates the installation location data 1824. In a preferred embodiment the calibration routine 1826 includes executable program instructions.

FIG. 16 is a flow chart illustration of a process 1900 executed by the processor 1808 (FIG. 15) during a calibration process of the solar panel installation 10. The process 1900 may be performed upon the completion of the solar power plant installation to generate the installation location data 1824 (FIG. 15) that the node controller 118 can use to more accurately position panels within the row for increased power generation. This embodiment will be described in the context of the solar power plant as illustrated in FIG. 14 configured as a decentralized system with a plurality of solar panel arrays 12-14 (i.e., rows/tracker tables), where each row includes its own drive system. In this embodiment, in step 1902 a master controller located proximate to or remote from the solar power plant 10 (FIG. 14) sends a power boost calibration command signal to each node controller 118 (see FIG. 13). The calibration command signal may be sent via a wireless communication channel, for example using a ZIGBEE network, or via a wireline connection from the master controller to the node controllers. In a preferred embodiment the process 1900 is performed on a day when full sun is expected throughout the day. On a calibration day when full sun is expected throughout the day, the charging current generated by the row of photovoltaic panels is measured periodically as the sun rises and the panels are held at a fixed position. The weather data may be available to the master controller via its wireless or wireline access to online weather data bases, such as for example, forecasting services DarkSky and Openweathermap.

In response to the power boost calibration command signal, each node controller 118 executes a power boost system calibration routine 1838 (FIG. 15) and commands its associated drive to rotate the panels in the row to a known position. FIG. 14 illustrates the panels in each row (in a flat position) in response to the command signal from its associated node controller. In response to receiving this command, referring still to FIG. 16, in step 1904 each node controller 118 determines if its local time is AM or PM. If it is AM, then in step 1906 the node controller disables its battery charger and commands its drive to rotate the panels in the row to a known calibration position (e.g., 30 degrees East). This ensure measurable current flows on the line 1802 (FIG. 15). FIG. 14 illustrates the panels in each row in a known calibration position. Referring again to FIG. 16, in step 1908, the controller 118 then measures the current flowing from the charging panel. For example, referring to FIG. 15, the controller measures the DC current on the line 1802 via the current sensor 1804. The node controller may take a number of current measurements over a period of time, and average or filter the measured current values to provide a rolling averaged charging current value. Once the rolling averaged charging current value is determined, then in step 1910 the node controller periodically (e.g., every 30-seconds) measures the charging current on the line 1802 and in step 1912 compares the measured charging current to the rolling averaged charging current value. In step 1912 the processor 1808 (FIG. 15) compares the measured current value versus the rolling average to assess if a shade transition has occurred. As the sun rises high enough, the shading of the adjacent panels end and the charging current increases dramatically as the charging panel moves into full sun (e.g., a sharp increase in charging current indicates end of shade). This transition may be detected by regularly comparing the measured versus the rolling average charging current. If step 1912 indicates a current change indicative of a shade transition, then the process proceeds to step 1914 and calculates a height offset of the adjacent row of panels. Since each of the node controllers are time synchronized, and for each row/tracker table it is determined when a shade transition occurs, then based upon the time of day of the detected shade transition, day of the year and the location, the time difference of the detected shade transition for each tracker panel can be used to determine the relative elevation of adjacent tracker tables. The calculation is performed using the known angle of the tracker and the elevation of the sun when the transition occurred to calculate the height offset of the tables. The detected shade transition information from each node controller in the solar panel installation 10 may be provided to the master controller in step 1916. This process is repeated on the western side as the sun sets and charging current drops dramatically when shading begins, as set forth in steps 1918-1926. The current sampling and comparison steps 1912, 1914, 1922 and 1924 occur periodically (e.g., every 30-seconds) over a period of hours at times T₀-T_{N} as pictorially illustrated in FIG. 14 with various sun positions. Using the detected shade transition from each node controller, the master controller may compute the relative elevation of adjacent tracker tables. Of course, in a distributed processing embodiment, each node controller may also compute its relative elevation with respect to its adjacent tracker table rather than having the computation performed in the master and transmitted to the individual node controllers.

Once the relative ground elevation of the adjacent tracker tables to each individual tracker tables is known, the control logic in each node controller can be optimized to reduce/minimize shading of the adjacent tables given the relative ground elevation of the adjacent trackers. This may be performed by storing in memory 1822 (FIG. 15) the installation location data 1824 (FIG. 15) calculated in step 1914 (FIG. 16), which account for the non-planar topography of the ground the solar panel installation is located on. In this way, the optimization of the solar power plant as a whole can be optimized, resulting in a system power boost.

The power boost system calibration routine 1838 (FIG. 15) for individual table/row control seeks to determine custom height offsets for each table/row control that provides for optimized control that reduces/minimizes mutual shading between adjacent tracker tables/rows for increased power generation. Calculation of the height offsets may performed at either the node controller level, or by the master and the information indicative of the relative elevation of the adjacent tracker tables used by the node controllers to reduce shading.

All adjacent tracker tables/rows running in the east-west direction may be represented as an array of height offsets from one table/row to the table/row immediately adjacent to it. At each sun angle considered, all tables are assumed to first face perpendicular to the incoming irradiance. Then, for each table, the angle between the straight-line projection of the trailing edge of one module to the leading edge of the panel on the adjacent table is calculated. This angle is called the Projection Angle (<P) and is compared to the sun elevation angle. If the sun elevation angle is smaller than the Projection Angle, then both tables involved (the table casting the shadow and the table being casted on) in the calculation are flagged as “SHADED”. After each table in the array has been iterated through, all tables flagged as “SHADED” have their tracker angles decreased by a fixed value (e.g., 0.125 degrees). The process is then repeated until tables either do not have a “SHADED” flag or are in a flat stow. FIG. 14 is a pictorial illustration of the trigonometry associated with the calculating the Projection Angle (<P).

Each tracker table may store internally in its node controller 118 (FIGS. 13 and 15) the height offsets of the tables to the east and west. At each given sun angle, the node controller 118 calculates which uniform tracking angle Θ will avoid shading with the adjacent tracker on one side given the height offset. The same calculation is repeated for the adjacent tracker table on the other side. The node then goes with the shallower tracking angle. FIGS. 17A-17J are pictorial illustrations of the trigonometry associated with calculating a uniform tracking angle Θ that avoids shading with the adjacent tracker on one side given the height offset (Δh) of the trackers, and equations that may be used based upon the trigonometry. The uniform tracking angle Θ may be calculated using the two primary equations for the case of variable height as follows.

$$θ = {sin}^{- 1} [ sin ( φ - {tan}^{- 1} ( \frac{Δ h}{R S} ) ) * \frac{\sqrt{{( Δ h )}^{2} + {( R S )}^{2}}}{w} ] - ϕ$$

$$θ = {sin}^{- 1} ( sin ( φ + {tan}^{- 1} ( \frac{Δ h}{R S} ) ) * \frac{\sqrt{{( Δ h )}^{2} + {( R S )}^{2}}}{w} ) - ϕ$$

In an aspect of the disclosure details of the calculations are set forth in FIGS. 17A-17J.

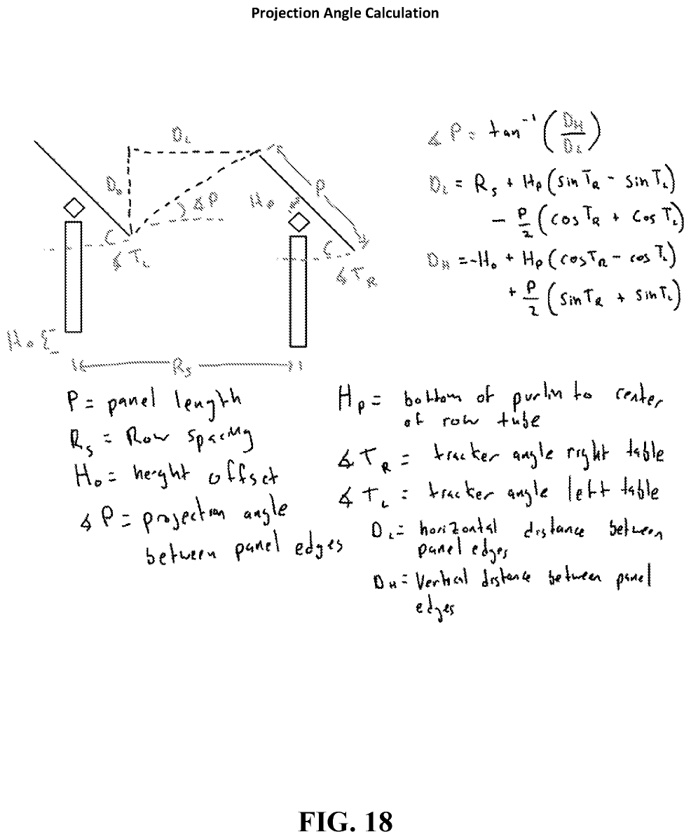

FIG. 18 is a pictorial illustration of trigonometry associated with calculating a Projection Angle (<P), which is the angle between the straight-line projection of the trailing edge of one module to the leading edge of the panel on the adjacent table. This angle is compared to the sun elevation angle. In this embodiment if the sun elevation angle is smaller than the Projection Angle, then both tables involved (the table casting the shadow and the table being casted on) in the calculation may be flagged as “SHADED”. After each table in the array has been iterated through, all tables flagged as “SHADED” have their tracker angles decreased by a fixed value (e.g., 0.125 degrees). The process is then repeated until tables either do not have a “SHADED” flag or are in a flat stow.

The present disclosure discloses a technique to automate the determination of the relative elevation of adjacent trackers to the east and west of each individual tracker table and operate each table using tilt angle versus time of day and day of the year that is based upon information indicative of the land the solar panel installation 10 (FIG. 14) is located on to optimize energy output of the solar panel installation. Additional hardware, such as a pyranometer, is not required in comparison to conventional single axis trackers to perform the disclosed calibration technique.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An assembly for a solar panel installation, the assembly comprising:
a stationary structural member having a length that extends longitudinally to a distal member end;
a rotatable shaft rotatably connected to the stationary structural member at the distal member end to rotate about a rotatable axis;
a drive mechanism connected to the rotatable shaft to rotate the rotatable shaft about the rotational axis in response to a command signal;
a node controller that provides the command signal;
a photovoltaic panel that rotates with the rotatable shaft about the rotatable axis and provides electrical current and is located at a known rotational position about the rotational axis; and
a current sensor that measures the electrical current and provides a sensed current signal indicative thereof;
where, the node controller includes executable program instructions that receive the sensed current signal, and based upon (i) the known position of the photovoltaic panel (ii) sun angle on the photovoltaic panel for day of the year and time of the day of the year and (iii) the received sensed current signal, the node controller determines and stores height data indicative of the topography the stationary structural member is located on with respect to an adjacent assembly for the solar panel installation, as measured over a plurality of hours by the current sensor that provides the sensed current signal.

2. The assembly of claim 1, wherein the drive mechanism includes a motor.

3. The assembly of claim 1, wherein the drive mechanism comprises a hydraulic piston.

4. The assembly of claim 1, where the node controller computes the height data value, which includes a height offset value indicative of difference in height between the assembly and the adjacent assembly.

5. A node controller for a solar panel installation with a drive mechanism and a photovoltaic panel of an associated tracker table rotatably mounted on a stationary structural member to rotate about the rotational axis, the node controller comprising:
a processor;
a tilt measuring device configured to measure rotary position of the photovoltaic panel about the rotational axis and provide a tilt signal indicative thereof;
a clock;
a memory comprising a height value indicative of the relative difference in elevation of the associated tracker table versus an adjacent tracker table, for use with the processor to determine what the tilt of the solar panel should be for a time of day, a day, and the height offset value and based upon one or more of the following parameters: sun elevation, sun azimuth, row spacing and/or slope the associated tracker table is locate on for backtracking analysis;
one or more drivers configured to signal the drive mechanism to operate until an appropriate tilt of the photovoltaic panel is reached; and
a wireless communication device for communicating with another device.

6. The node controller of claim 5, wherein the another device is a master controller that communicates with a plurality of node controllers each uniquely associated with a one of the associated tracker table and adjacent tracker tables of the solar panel installation.

7. The node controller of claim 6, where the master controller comprises a snow/water depth sensor that provides data that can trigger a warning and/or an adjustment in an operational tilt range of the solar panel.

8. The node controller of claim 5, where the processor includes executable program instructions that cause the node controller to receive a measured current signal from the photovoltaic panel to (i) determine at what time the sun substantially illuminates the associated tracker table that includes a photovoltaic (PV) panel selectively electrically connected to a battery, based upon a detected increase in the measured current signal, and to (ii) determine at what time the sun is shaded from substantially illuminating the associated tracker table based upon a detected reduction in the measured current signal.

9. The node controller of claim 5, where the processor includes executable program instructions that cause the node controller to measure current from the associated tracker table during a calibration process to determine the time of day when the sun begins to directly illuminate the photovoltaic panel without shading from a first adjacent tracker table in the East-West direction, and to measure the current from the photovoltaic panel during the calibration process to determine the time of day when the sun stops directly illuminating the associated tracker table because of shading from a second adjacent tracker table in the East-West direction.

10. The node controller of claim 5, where the processor includes executable program instructions that cause the node controller to rotate the photovoltaic panel to track the sun accounting for the elevation of the associated tracker table relative to first and second adjacent tracker tables in East-West directions using the height value indicative of the height difference of the associated tracker table versus one of the first and second adjacent tracker tables, and sets a tilt angle for the associated tracker table based upon the height value to increase energy output of the associated tracker table.

11. The node controller of claim 5, where the processor includes executable program instructions that cause the node controller to rotate the photovoltaic panel of the associated tracker table to track the sun accounting for the elevation of adjacent tracker tables in the East-West direction.

12. A master controller for communicating with a plurality of node controllers of a solar panel installation, each of the plurality of node controllers associated with one of a plurality of tracker tables, the master controller comprising:
a processor configured with a memory and a communication device in order to
periodically synchronize node clocks of the plurality of node controllers with a master clock of the master controller to ensure coordinated tilts of the plurality of tracker tables;
command the plurality of node controllers to perform a power boost calibration routine that for each of the plurality of tracker tables measures, periodically over a period of hours, electrical current generated by a photovoltaic panel commanded to a known calibration position;
receive, for each of the plurality of tracker tables, shade transition data indicative of a transition of the electrical current from each of the plurality of tracker tables;
compute relative elevation data for each of the plurality of tracker tables based upon the shade transition data indicative of a transition of the electrical current from each of the plurality of tracker tables; and
transmit the relative elevation data to the plurality of node controllers.

13. A master controller for communicating with a plurality of node controllers of a solar panel installation, each node controller associated with one of a plurality of tracker tables, the master controller comprising:
a processor configured with memory and a communication device in order to
(i) periodically synchronize node clocks of the node controllers with a master clock of the master controller to ensure coordinated tilts of the plurality of tracker tables;
(ii) command the node controllers to perform a power boost calibration routine that measures, periodically over a period of hours, electrical current generated by a photovoltaic panel commanded to a known calibration position; and
(iii) receive, from each of the node controllers, a height offset value indicative of the height of the tracker table associated with the node controller relative to an immediately adjacent tracker table, where each of the height offset values is computed by its associated node controller based upon measured shade transitions as determined by the associated node controller monitoring electrical current from its associated tracker table held in a known position of a period of hours during a calibration day.

14. A method of determining a height offset data indicative of height offset between a first solar tracker table and an adjacent second solar tracker table, the method comprising:
rotating a photovoltaic panel of the first solar tracker table to a known position;
measuring electrical current from the first solar tracker table and providing a measured current signal indicative thereof;
comparing the measured current signal with a rolling time average of the measured current signal to determine if a shade transition has occurred;
repeating the steps of measuring and comparing if the step of comparing determines that a shade transition has not occurred; and
when it is determined that a shade transition determine has occurred, calculating the height offset data indicative of a difference in height between the first solar tracker table and the second solar tracker table.

15. The method of claim 15 where the calculating the height offset data uses (i) known position of the photovoltaic panel (ii) sun angle for day of the year and time of the day of the year and (iii) the measured current signal.
